(19) United States
(12) Patent Application Publication
(10) Pub. No.: US 2020/0236610 A1
(43) Pub. Date: Jul. 23, 2020

(54) METHOD AND SUBSCRIBER IDENTITY COMPONENT FOR PROVIDING NETWORK ACCESS

(71) Applicant: TELE2 IOT AB, kista (SE)

(72) Inventors: Daniel MARTIN, Sollentuna (SE); Pontus WINBLAD, Nacka (SE); Jan BOVENBERG, Stockholm (SE); Jonas HALLMAN, Sollentuna (SE); Stephen BRYANT, Enskede Gård (SE)

(21) Appl. No.: 16/650,427

(22) PCT Filed: Sep. 25, 2018
(86) PCT No.: PCT/EP2018/075951

§ 371 Date: Mar. 25, 2020

(30) Foreign Application Priority Data
Sep. 25, 2017 (SE) 1751187-4

(51) Int. Cl. H04W 48/08; H04W 8/18; H04W 8/20; H04L 29/12

(52) U.S. Cl. CPC H04W 48/08; H04L 61/6054; H04W 8/205; H04W 8/183

(57) ABSTRACT

A method and a subscriber identity component for providing a wireless device with access to a network node are disclosed. The subscriber identity component is provisioned with information defining a set of pools relating to pool subscriber identities. The subscriber identity component determines a pool subscriber identity based on a pool among the set of pools. The subscriber identity component checks a connection state relating to whether or not the wireless device is granted access to the network node by use of the pool subscriber identity. Furthermore, when the connection state indicates that the wireless device is granted access to the network node, the subscriber identity component provides the wireless device with access to the network node based on the pool subscriber identity. Furthermore, a corresponding computer program and a computer program carrier are disclosed.

### TECHNICAL FIELD

Embodiments herein relate to connectivity management for subscriber identity components, such as SIMs, UICCs, eUICCs and the like, for use in wireless communication systems, such as cellular networks and the like. In particular, a method and a subscriber identity component for providing a wireless device with access to a network node are disclosed. A corresponding computer program and a computer program carrier are also disclosed.

### BACKGROUND

A mobile device, operable in wireless systems like telecommunication system, is equipped with a unique subscriber identity, often referred to as an International Mobile Subscriber Identity (IMSI). The unique subscriber identity, as well as other credentials, is used when the mobile device gains access, or attaches, to a network, such as cellular network, a telecommunication network, or the like. The unique subscriber identity is typically stored in a Universal Integrated Circuit Card (UICC), which can be inserted into the mobile device.

The UICC is personalised, i.e. assigned a particular IMSI, before it is inserted into the mobile device. This kind of personalisation can be performed by a manufacturer of the UICC, often a long time before a wireless device is provided with the UICC and subsequently powered on in the network. The IMSI determines, among other things, the local network to be to which the IMSI belongs, as well as to which roaming networks, in addition to the local network, the UICC is allowed to attach. Roaming agreements between operators for the stored IMSI ensures that the IMSI can attach to additional networks other than the local network of the IMSI. When the UICC with the assigned IMSI is inserted into a device, it is thus already decided in which region it can be operated. The particular IMSI needs to be activated in e.g. a Home Location Register (HLR), i.e. a back-end network operator system, in order for the device to gain access to the network(s).

In order to solve various issues related to personalizing of Subscriber Identity Modules (SIMs), US20110136482 proposes a method for commissioning and personalizing a subscriber identification module (SIM). The SIM is initially set up, prior to a first commissioning, with a preliminary subscriber identification (IMSI*), included in a preliminary non-individual data set (S*). The preliminary non-individual data set (S*) allows the first commissioning of the SIM in a mobile telecommunications network to be successful. Personalizing is then performed after the first commissioning of the SIM, in that an individual and final subscriber data set (S) is transferred to and stored on the SIM, particularly comprising a unique final subscriber identification (IMSI) and a unique final secret key (K), particularly in that the final subscriber data set (S) is transferred by means of a regular connection of the mobile telecommunications system using the preliminary set (S*).

The number of potential preliminary subscriber data sets is prescribed and is particularly much less than the total number of subscriber identification modules (SIM) equipped with said data sets. Therefore, the preliminary IMSI* is reused cyclically in the initial set up in order to equip the total number of SIMs. According to US20110136482, an accidental accumulation of one or more of the non-individual subscriber data sets (S*) does hence not occur for a customer that obtains a batch of SIMs taken from the total number of SIMs. Consider a scenario, e.g. relating to Internet-of-Things (IoT), when a customer needs service for an unknown amount of devices, it may then happen that the customer needs to obtain a first batch and later a second batch of SIMs.

A disadvantage may then be that when the customer obtains the second batch of SIMs taken from the total number of SIMs, an accidental accumulation of one or more non-individual subscriber data sets may indeed occur within the first and second batches seen as a whole. A reason for this may be that it cannot be ensured, or may not be desired to ensure, that the entirety of the first batch has been personalized over the air before the second batch is deployed.

### SUMMARY

An object may be to overcome, or at least alleviate, the above mentioned disadvantage relating to network access, or connectivity, using subscriber identity components, such as the above mentioned UICC, embedded UICC, SIM or the like.

According to an aspect, the object is achieved by a method, performed by a subscriber identity component, for providing a wireless device with access to a network node. The subscriber identity component is provisioned with information defining a set of pools relating to pool subscriber identities. The subscriber identity component determines a pool subscriber identity based on a pool among the set of pools. Moreover, the subscriber identity component checks a connection state relating to whether or not the wireless device is granted access to the network node by use of the pool subscriber identity. When the connection state indicates that the wireless device is granted access to the network node, the subscriber identity component provides the wireless device with access to the network node based on the pool subscriber identity.

According to another aspect, the object is achieved by a subscriber identity component configured to perform the method above.

According to further aspects, the object is achieved by a computer program and a computer program carrier corresponding to the aspects above.

Thanks to that the subscriber identity component determines, such as calculates, the pool subscriber identity based on a pool among the set of pools, the pool subscriber identity may be determined within the pool, e.g. during an attempt to obtain network access. The pool subscriber identity may be determined randomly, or quasi-randomly, within the pool. This means that the subscriber identity component, according to the embodiments herein, may be completely free from any particularly assigned subscriber identity, e.g. up until the subscriber identity component is about to seek connectivity, e.g. to make an attempt to access the network node. For example, the subscriber identity component may hence not be personalized with any particularly assigned subscriber identity during so called personalization. According to prior art, e.g. a SIM is provided with an IMSI during personalization, typically long before first deployment in the field. Thanks to that the pool subscriber identity is determined as part of the attempt to obtain network access, i.e. to access the network node, aforementioned any accidental accumulation of any particularly assigned subscriber identities does not occur. As a result, the abovementioned object is achieved.

An advantage is that a risk for simultaneous use of two subscriber identities is predictable irrespectively of from which batch the subscriber identity component originates.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic overview of an exemplifying network in which embodiments herein may be implemented,

FIG. 2 is a combined signaling and flowchart illustrating the methods herein, and

FIG. 3 is a block diagram illustrating embodiments of the subscriber identity component.

### DETAILED DESCRIPTION

In order to better appreciate the embodiments herein, some further observations and explanations are provided here.

Subscriptions for any device must be activated in Mobile Network Operator (MNO)/Home Subscriber System (HSS)/Home Location Register (HLR) in order for the device to gain access to a network. In scenarios, such as IoT scenarios, where massive amounts of devices may be rolled out, the activation of subscriptions consume IMSIs, Mobile Station International Subscriber Directory Numbers (MSISDNs) and the like. This is problematic since the number of IMSIs and/or MSISDNs are/is not unlimited and there may be costs related to each activated IMSI and/or MSISDN. The cost may be related to license fees or similar.

In order to reduce cost and consumption of IMSIs and/or MSISDNs, estimations of a maximum number of subscribers, e.g. in terms of devices that may need connectivity, in each region are made. While it is desired that the estimations are conservative, to reduce consumption and cost, it shall also be ensured that one never runs out of active subscriptions, or active IMSIs. Running out of subscriptions would of course be detrimental to sales of subscriptions. A problem may thus be how to estimate number of IMSIs to keep in stock, i.e. available for use in a region.

In view of the above, it appears beneficial to be able to incrementally increase number of IMSIs managed by a service provider using a network. That is to say, it is expected that the service provider may order several batches of subscriber identity components as need for IMSIs increase.

Furthermore, this means that a UICC with an assigned IMSI is specific for a particular region, i.e. the region in which the subscriber/device is intended to be operated. A problem is hence that if a device is started in an unsupported region (without roaming agreement), the device will not be able to attach to the network. Consequently, the device will not be operational, e.g. data, such as voice data or the like, cannot be exchanged with the device. Therefore, for existing solutions to work, it is required that a particular UICC, assigned with a particular IMSI, is sent to regions which it supports, i.e. regions in which it is operational.

Additionally, in many scenarios the device may be operational also in other networks than its local network, e.g. due to a roaming agreement. A problem may then be that the roaming agreement may not allow roaming for more than only a limited time, which would cause the device to eventually become non-operational. Another problem may be that cost for roaming may, at least over time, be unnecessarily high.

In addition to this, global deployments of devices will typically create extensive logistical as well as stock keeping challenges, as each device needs to be equipped with an UICC/IMSI suitable or even optimal for the intended area of use for that particular device, and only devices with the suitable IMSI ought to be sent to the intended area.

Thus, devices for each area need to be kept in stock, and the shipment of the correct device to the correct area needs to be handled. Further, if a device manufacturer or reseller is working with several different operators, a stock needs to be kept for each operator and for each specific area.

At least one embodiment herein may alleviate at least one of the above mentioned problems and disadvantages.

Throughout the following description, similar reference numerals have been used to denote similar features, such as nodes, actions, modules, circuits, parts, items, elements, units or the like, when applicable. In the Figures, features that appear in some embodiments are indicated by dashed lines.

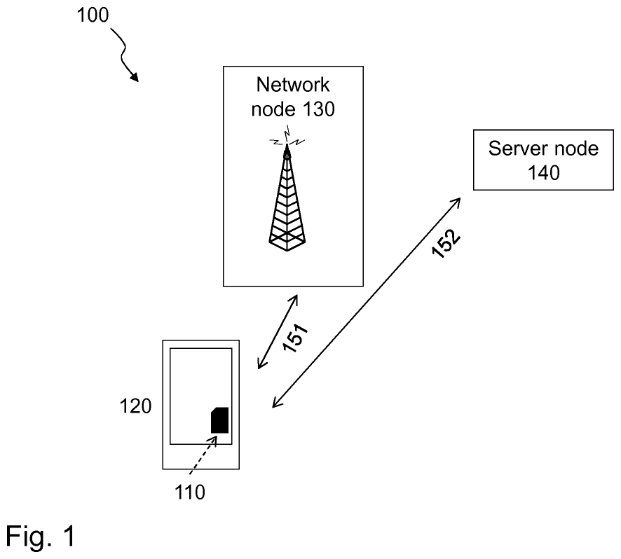

FIG. 1 depicts an exemplifying network 100 in which embodiments herein may be implemented. In this example, the network 100 is a Global System for Mobile communication (GSM) network.

In other examples, the network 100 may be any cellular or wireless communication system, such as a Long Term Evolution (LTE), Universal Mobile Telecommunication System (UMTS) and Worldwide Interoperability for Microwave Access (WiMAX) or the like.

The network 100 may be said to comprise a wireless device 120. This means that the wireless device 120 is present in the network 100, i.e. within coverage of the network 100.

A subscriber identity component 110 is illustrated as being comprised in the wireless device 120. This means that the subscriber identity component 110 may be inserted into the wireless device 120 in a removable manner. Alternatively, the subscriber identity component 110 may be integrated with the wireless device 120 in a non-easily removable manner, e.g. soldered or as part of an integrated circuit of the wireless device 120. Further examples of the subscriber identity component 110 include, but are not limited to, a Subscriber Identity Module (SIM), eUICC, iUICC, ICC, smart card, soft-SIM, embedded SIM, SIM/soft-SIM in combination with application software in the wireless device or the like. A soft-SIM may refer to that no particular SIM hardware exists and all SIM functionality is carried out by a software layer, such as a program or the like.

The subscriber identity component 110 may, prior to first start-up, be provided with information defining a set of pools. Based on a pool taken from among the set of pools one or more pool subscriber identities may be derived. As an example, the pool may be defined by a so called Public Land Mobile Network (PLMN) identity, which is a combination of a Mobile Country Code (MCC) and Mobile Network Code (MNC) and two values indicative of a range in which subscriber identities may be determined as in action A020 below.

Each pool may be associated with a respective region. The respective region may be a coverage area of a network with or without roaming. Hence, the respective region may include one or more countries, geographical areas or the like. The respective region may be associated with a mobile network operator, which in turn also may be identified by a PLMN. At least one respective region is at least partially non-overlapping with at least one further respective region.

The network 100 further comprises a network node 130 for managing access to the network 100. The network node 130 may comprise a Home Subscriber System, Home Location Register or the like.

Moreover, a server node 140 for managing traffic subscriber identities is illustrated in FIG. 1. The server node 140 may be a Subscription Manager (SM), a Subscription Manager Data Preparation (SM-DP), a Connectivity Management Gateway (CMG) or the like. Once the wireless device 120 is allowed into the network 100, the subscriber identity component 110 may communicate with the server node 140.

The network node 130 may communicate 151, e.g. via the wireless device 120 with the subscriber identity component 110. Furthermore, the server node 140 may communicate 152, e.g. via the wireless device 120, with the subscriber identity component 110.

In the context of the present disclosure, the following terms may be used.

The term “traffic subscriber identity” may refer to that such subscriber identity is permanent or temporary. Such traffic subscriber identity is typically unique, but may in some cases be non-unique. The traffic subscriber identity may typically be different, i.e. have different value, from so called pool subscriber identities as explained below. Notably, the traffic subscriber identities need also be active in the same sense as the pool subscriber identities in order to be able to provide connectivity when used.

The term “pool subscriber identity” may refer to that the subscriber identity is associated with a valid and active subscription according to a database, such as an HLR database, HSS database or the like. It shall be noted that the terms “traffic” and “pool” have been used merely to distinguish between these subscriber identities. A difference between traffic subscriber identities and pool subscriber identities is though that a pool subscriber identity is determined, or generated, when a need for connectivity arises, while a traffic subscriber identity is assigned to a certain subscriber identity component regardless whether or not the certain subscriber identity is involved in an attempt for obtaining connectivity or not.

The term “component identity” may refer to ICC identification (ID), EID, or any other identification indicating the subscriber identity component 110.

The term “device identity” may refer to an International Mobile Equipment Identity (IMEI) or the like.

The term “subscriber identity” may refer to an International Mobile Subscriber Identity (IMSI) or the like.

The term “region” may refer to an operator's network coverage area, a country, a group of countries, business or customer segment in relation to an operator, or the like.

Moreover, the term “wireless device” may refer to a user equipment, a machine-to-machine (M2M) device, a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor device may detect any kind of metric, such as wind, temperature, air pressure, humidity, light, electricity, sound, images etc. Accordingly, the wireless device may refer to any so called IoT-device.

Furthermore, as used herein, the term “network access”, “access granted”, “gain access” and the like may refer to that the wireless device is allowed into the network 100 and is able to transmit and/or receive messages using the network 100. The term “connectivity” has been used interchangeably.

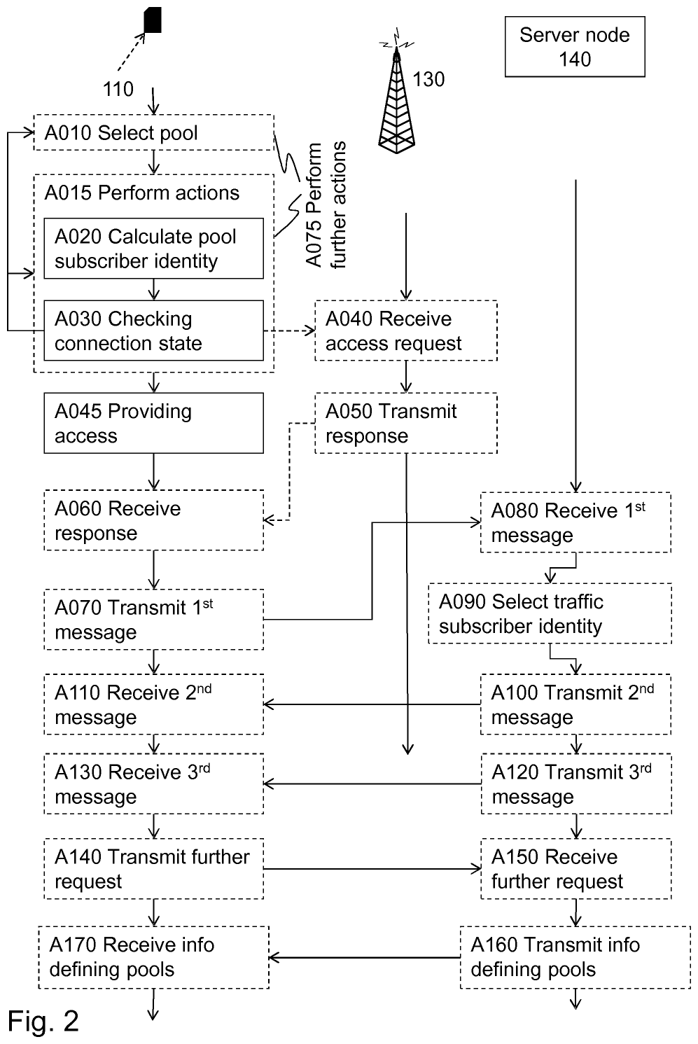

FIG. 2 illustrates an exemplifying method according to embodiments herein when implemented in the network 100 of FIG. 1.

The subscriber identity component 110 performs a method for providing the wireless device 120 with access to the network node 130.

The subscriber identity component 110 is provisioned with information defining a set of pools relating to pool subscriber identities. This means that the subscriber identity component 110 has not been provided with any particular subscriber identity, but instead the subscriber identity component 110 has been provided with the information defining the set of pools from which the subscriber identity component 110 is able to derive, e.g. determine, calculate etc., a pool subscriber identity, e.g. to be used upon when seeking connectivity in, e.g. attempting to access, the network 100. Expressed differently, the subscriber identity component 110 may have been provisioned with no subscriber identity, i.e. without any subscriber identity. In particular, the subscriber identity component 110 may be provided without any subscriber identity prior to first start-up, such as a first commissioning.

In order not to obscure the embodiments herein, many details realized by the skilled person are left out of the following description. For example, so called fresh commands, acknowledgement and the like have been left out for ease of description. Conceptually, the embodiments herein are nevertheless fully described in order for a skilled person to implement one or more of embodiments herein.

One or more of the following actions may be performed in any suitable order.

### Action A010

The subscriber identity component 110 may select a pool among the set of pools. As an example, the subscriber identity component 110 may select the pool based on the information defining the set of pools. The information may for example identify one or more PLMN Codes (PLMNs, that is an MCC combined with an MNC), each of which may represent a respective pool. When the set of pools only includes one pool, the subscriber identity component 110 simply uses that one pool and no particular selection may need to be made. Therefore, action A010 is optional.

In some embodiments, the subscriber identity component 110 may select the pool by one of:

selecting the pool according to a predefined order for the set of pools,

selecting the pool randomly among the set of pools, and

selecting the pool based on location of the wireless device 120.

In first example, when the subscriber identity component 110 selects the pool according to a predefined order, it may be preferred that a network with a largest possible coverage, with or without roaming, is first in order, next a network with large coverage, but that slightly differs from the coverage of the network first in order, is put as second in order. The predefined order may then continue like this for any number of networks, i.e. PLMNs. The predefined order is in this example based on size of coverage area, but in other examples the predefined order may, alternatively or additionally, be based on probability that a first commissioning is performed in a certain region.

In a second example, when the subscriber identity component 110 selects the pool randomly among the set of pools, it may be that all networks, each representing a respectively pool, may have about the same coverage and no network is therefore preferred over the other. An advantage may be that the load on the different networks may in this way be randomly distributed, i.e. quasi-evenly distributed.

In a third example, when the subscriber identity component 110 selects the pool based on the location of the wireless device 120, it may be that the subscriber identity component 110 has requested the wireless device 120 to provide its position, e.g. as obtainable via a WiFi-connection or the like. In this case, the subscriber identity component 110 may select the pool, whose corresponding network has coverage at the provided position.

### Action A015

The subscriber identity component 110 may perform a set of actions, i.e. action A020 and A030 below, until the wireless device 120, identified by the pool subscriber identity, gains access to the network node 130 or until a condition relating to a number of checks of the connection state, as in action A030, is fulfilled.

This means that the set of actions may be performed until the subscriber identity component 110 obtains service, i.e. normal service, in the network 100. The subscriber identity component 110 may not have obtained normal service for various reasons, such as that the determined subscriber identity was not useful or erroneous in some way.

As an example, the condition may be that at least a certain number of checks, i.e. attempts to obtain access, shall be made. The certain number of checks may be any suitable integer value, such as 1, 2, 3, or the like. In some examples, it may be that attempts to gain access with three different pool subscriber identities from the same pool may be considered enough to dismiss the pool as unsuitable for the region in which the wireless device 120 is present. Of course, very high values may induce unnecessarily long time before it is decided to proceed with the next pool as explained below in action A075.

### Action A020

In order to make an attempt to obtain service, the attempt is required to be accompanied by a subscriber identity. Therefore, the subscriber identity component 110 determines a pool subscriber identity based on a pool among the set of pools. The pool may have been selected in action A010, but in case the set of pools only comprises one pool, no selection needs to be performed and the one and only pool is used. It shall be noted that the traffic subscriber identity to be obtained is different from the pool subscriber identity determined based on the pool. As a result of the determination, the subscriber identity component 110 is provided with the pool subscriber identity to be used for accessing e.g. the network node 130. This thus means that the pool subscriber identity may be determined as a part of an attempt to access the network node 130, i.e. when the subscriber identity component 110 supports the wireless device 120 in seeking connectivity.

As an example, the pool subscriber identity may be calculated as follows. The pool may be identified by a PLMN identity, or PLMN Code, and a start-offset and a length. The length may of course instead be defined by a stop-offset considered in relation to the start-offset. Let's assume the PLMN to be 24007. The start-offset may be 9990000 and the length may be 500. Then the calculation may randomly, or quasi randomly, generate any subscriber identity in the range from 240079990000000 to 240079990000499. Should it be desired the range may be defined as from 240079990000001 to 240079990000500 or the like. Notably, the PLMN id may include 5 or 6 digits as is known in the art. In this manner, a risk for simultaneous attempts to obtain service from two different wireless devices whose respective subscriber identity components have accidentally calculated the same pool subscriber identity is predictable based on a length of the pool, estimated number of wireless device to be deployed per unit time and average time using the pool subscriber identity to utilize any service e.g. provided by the server node 140.

For example, a so called Erlang B Calculator may be used, see e.g. http://www.erlang.com/calculator/erlb/. The Erlang B Calculator is based on a traffic model established by A. K. Erlang, a Danish scientist who was responsible for much of the early work in telephone traffic theory. With this calculator any one of three parameters may be determined. The three parameters are: Busy Hour Traffic (BHT), Blocking and Lines, where Lines correspond to the length of the pool. Assume the length to be 55. BHT may be 40, given that there are 0.1 wireless devices to be deployed per second and average time for using the pool subscriber identity is 400 seconds. The collision probability would then be 0.4% as obtained from this calculator.

In particular, the risk is independent of from which batch of subscriber identity components the respective subscriber identity components of the two different wireless devices originates. A batch may refer to a sequence of consecutive subscriber identity components which may have been delivered, or are to be delivered, to a customer, aka service provider. Here, the term “consecutive” may be understood as in relation to the component identity. Furthermore, the risk is predictable, i.e. without uncertainty concerning from which batch the subscriber identity component 110 originates.

It may here be noted that e.g. a SIM card according to prior art which for some reason isn't personalized with a particular IMSI, would cause the wireless device 120 to display a message like “no SIM”, “SIM error” or the like.

In more detail, action A020 may be invoked at an event, e.g. EVENT_FIRST_COMMAND_AFTER_ATR known from e.g. 3rd Generation Partnership Project (3GPP) TS 31.130. Then the determined IMSI may be read by the wireless device 120 in connection with a so called refresh after which action A030 may be performed.

Furthermore, a secret key K (and corresponding secret key OPC) is obtained, e.g. read from a memory of the subscriber identity component 110, generated or the like, by the subscriber identity component 110. In related literature, the secret key K is often denoted Kᵢ and is used in a conventional manner herein. The secret key K (and OPC) may be used for all pool subscriber identities, i.e. one secret key K for the entire pool, or there may be a respective key K (and OPC) for each determined pool subscriber identity in the pool.

### Action A030

Subsequent to action A020, the subscriber identity component 110 checks a connection state, i.e. whether or not service is normal (available), limited or non-existing. The connection state may relate to access attempts towards the network node 130 by use of the pool subscriber identity, i.e. whether or not the wireless device 120 is granted access to the network node 130.

The subscriber identity component 110 may for example check the connection state using at least one of: a location information event, periodical checks for Elementary File Location Information (EF LOCI) file update, and one or more periodical proactive commands to instruct the wireless device to provide local information and the like. In this manner, the connection state, i.e. resulting from an attempt to obtain service using the pool subscriber identity, may be established by the subscriber identity component 110.

As an example, the subscriber identity component 110 sends a command to the wireless device 120. The command may be a so called proactive command, such as PROVIDE LOCAL INFORMATION according to 3GPP Technical Specification Group Core Network and Terminals, Universal Subscriber Identity Module (USIM) Application Toolkit (USAT), TS 31.111. This means that the access request may be the PROVIDE LOCAL INFORMATION command or the like that is provided to the wireless device 120, which in its turn transmits the access request, or another message derived from the command, over the air to the network node 130. Expressed differently, the transmission A030 of the access request may be performed via the wireless device 120.

It may be seen as that the wireless device 120 transmits, to the network node 130, an access request for accessing the network node 130 in response to the check of the connections state. The access request comprises the pool subscriber identity.

### Action A040

Subsequently to action A030, the network node 130 may thus receive the access request from wireless device 120. As mentioned, the request may sometimes be caused by that the subscriber identity component 110 performs the check of the connection state.

### Action A045

When the connection state indicates that the wireless device 120 is granted access to the network node 130, the subscriber identity component 110 provides the wireless device 120 with access to the network node 130 based on the pool subscriber identity. For example, the access to the network 100 may be based on the pool subscriber identity also when e.g. communication with the network 100 is using a so called Temporary-IMSI (T-IMSI).

### Action A050

Before transmitting a response to the wireless device 120, which informs the subscriber identity component 110 about the contents of the response, the network node 130 may determine based on the pool subscriber identity whether or not to grant access to the network 100.

When the pool subscriber identity can be granted access, the network node 130 sends a response indicating that access is granted.

When the pool subscriber identity cannot be granted access, the network node 130 sends a response indicating that access is denied.

### Action A060

Subsequently to action A050, the subscriber identity component 110 may thus receive the response, or rather information derived from the response. The subscriber identity component 110 may then determine, based on the response, whether or not access to the network 100 has been granted. Expressed differently, the wireless device 120 has connectivity when access is granted.

In one example, the subscriber identity component 110 may have requested the wireless device 120 to provide so called local information. In response to such request, the subscriber identity component may receive—when service is available—a TERMINAL RESPONSE, e.g. according to TS 31.111, including one or more of:
location information: the mobile country code (MCC), mobile network code (MNC), location area code/tracking area code (LAC/TAC) and cell ID of the current serving cell;
the IMEI or IMEISV of the ME;
the Network Measurement Results (and the BCCH channel list if connected to GERAN);
the current date, time and time zone;
the current ME language setting;
the Timing Advance, suitable only for GERAN;
the current access technology;
the current network search mode;
the charge state of the battery (if class “g” is supported);
the WSID of the current I-WLAN connection;
The CSG ID list and corresponding HNB names of detected CSG or Hybrid cells in the Allowed CSG list or the Operator CSG list (if class “q” is supported).

In more detail, the wireless device 120 first receives the response and converts it to a TERMINAL RESPONSE that is provided to the subscriber identity component 110.

### Action A070

When the connection state indicates that the wireless device 120 is granted access to the network node 130, the subscriber identity component 110 may transmit a first message to the server node 140. The first message may comprise a component identity relating to identification of the subscriber identity component 110 comprised in the wireless device 120.

In some embodiments, referred to as “personalization embodiments”, the first message may indicate to the server node 140 that a traffic subscriber identity is requested, and the server node 140 may manage traffic subscriber identities. With the personalization embodiments, an over the air personalization is initiated.

The first message may be a Notification message, e.g. according to 4.1.1.11 of GSM Association Technical Specification “Remote Provisioning Architecture for Embedded UICC”, version 3.2, of 27 Jun. 2017, which may be provided to the wireless device 120 which may transmit the first message to the server node 140. Hence, it may be said that the transmission A070 of the first message may be performed via the wireless device 120.

The component identity may be a eUICC ID (EID), an International Mobile Equipment Identity (IMEI), or the like. The IMEI may be used when the subscriber identity component is mounted, in a non-easily removable manner, in the wireless device 120 (e.g. the subscriber identity component 110 is soldered at a printed circuit board of the wireless device 120) and the EID, or the like, may be used when the subscriber identity component 110 is detachably inserted into the wireless device 120 (e.g. a sim-card that can be moved from one wireless device to another).

Moreover, in order to transmit the first message to the server node 140, the subscriber identity component 110 may retrieve an address, such as an Internet Protocol (IP) address, telephone number (MSISDN), SMS Transport Protocol—Destination Address (TP-DA) according to European Telecommunications Standards Institute (ETSI) 123.040 or the like, of the server node 140. The address may be stored in a memory of the subscriber identity component 110 and/or the wireless device 120, e.g. as a configuration file or the like. As an example, the information defining the set of pools may also be stored in the memory.

Thanks to that the first message includes the component identity, the server node 140 may be able to select the traffic subscriber identity based on the component identity. In this fashion, a particular customer, who obtained a batch including the subscriber identity component assigned with the component identity, may be identified.

Accordingly, the subscriber identity component 110 may, in the personalization embodiments, perform a method for obtaining a traffic subscriber identity for enabling the wireless device 120 to access the network node 130. As an example, the subscriber identity component 110 performs a method for enabling download of a traffic subscriber identity to be used by the wireless device 120 when accessing the network node 130. As mentioned above, the traffic subscriber identity may be unique or non-unique, temporary or permanent depending on use case.

In some other embodiments, referred to as “pool embodiments”, the first message may comprise payload data to be sent to the server node 140, and the server node 140 may manage the payload data received from the wireless device 120. In these embodiments, it may typically be that the wireless device 120 initiates communication with the network 100.

In this manner, the determined pool subscriber identity may actually be used when the wireless device 120 provides the payload data to the server node 140. Accordingly, the service provider may thus use one of the pool subscriber identities derived from the information about the set of pool for transmission of the payload data related to a service provided by the service provided. As one example, the service may relate to collection of measurement data. Then, the payload data may be measurement values reported to a central server for further processing, where the central server is an example of the server node 140.

### Action A075

When access is not granted, or the connection state indicates that the wireless device 120 fails to gain, i.e. is not granted, access to the network node 130, and optionally when the condition relating the number of checks of the connection state is fulfilled, the subscriber identity component 110 may proceed by performing a further set of actions.

The further set of actions may include that action A010 is performed and that the set of actions A015 are performed again. In this way, the subscriber identity component 110 ensures that the access request is re-attempted while using another PLMN (MCC combined with MNC) for which another subscriber identity is determined in action A020—as part of the set of actions A015.

An advantage of performing the further set of actions is that global connectivity, or global access, may be achieved. As an example, a first pool is associated with a first region, i.e. a coverage of a first network with or without roaming. Then, a second pool is associated with a second region, i.e. a coverage of a second network with or without roaming. These regions may preferably be at least partially non-overlapping. As a result, if no network can be found by use of the first pool, it may then be that a network can be found and access may be granted when the second pool is selected. Accordingly, an initial access may be provided irrespectively of in which region the wireless device 120 and the subscriber identity component 110 is located at a first commissioning.

In these cases, when access is not granted, the performance A015 of the set of actions continues until the wireless device 120 gains access or the condition is fulfilled, whereby a respective pool subscriber identity is determined for each execution of the determination A020, and a respective connection state is checked for each execution of the check A030.

The further set of actions may be performed while the respective connection state indicates that the wireless device 120 is denied access to the network node 130 and while a number of executions of the selection A010 of the pool is less than or equal to a value representing number of pools in the set of pools. This may mean that the further set of actions is repeated either until access is granted or until there are no further pools to attempt to gain access with. It may be noted that even when the pool is selected randomly, it may be that an already selected pool is removed from the set of pools such that the subscriber identity component 110 cannot randomly select the same pool more than once.

### Action A080

Subsequent to action A070, the server node 140 may receive the first message. In this manner, the server node 140 becomes aware of that the subscriber identity component 110 is deployed in the network 100 by use of the pool subscriber identity.

### Action A090

When the server node 140 may then, based on the component identity, select which traffic subscriber identity to be used in the subscriber identity component 110. Based on various rules and criteria, the traffic subscriber identity is thus selected by the server node 140. The various rules and criteria may take into account cost, geographical location, preferred partner etc.

### Action A100

In order to inform the subscriber identity component 110 about the traffic subscriber identity, the server node 140 may transmit at least one second message, comprising the traffic subscriber identity, to the subscriber identity component 110.

Said at least one second message may be a Download Profile message, such as ES8.DownloadAndInstallation message known from the above mentioned technical specification.

### Action A110

The subscriber identity component 110 receives said at least one second message from the server node 140. As a result, the subscriber identity component is made aware of the traffic subscriber identity that can be used when seeking service. The reception A110 of said at least one second message may be performed via the wireless device 120.

In some embodiments, action A110 may be preceded by that the subscriber identity component 110 receives a create profile message, such as ES5.CreateISDP or the like.

### Action A120

The server node 140 may transmit a third message to the subscriber identity component 110. The third message instructs the subscriber identity component 110 to use the traffic subscriber identity when attaching to the network node 130. The third message may be an Enable Profile message, such as ES5.EnableProfile again known from the above mentioned technical specification.

### Action A130

Subsequently to action A120, the subscriber identity component 110 may receive the third message from the server node 140. The subscriber identity component 110 may then following a so called refresh attempt to access the network 100, or another network (not shown), as in action A140 below.

### Action A140

Now that the new profile has been enabled in the subscriber identity component 110, the subscriber identity component 110 may need to instruct the wireless device 120 to refresh, such as REFRESH in UICC Reset according to ETSI Technical Specification (TS) 102.223. Next, an attempt to attach to the network 100 with the traffic subscriber identity, which the server node 140 may have considered to be the currently most suitable subscriber identity, may be made.

Consequently, the subscriber identity component 110 may be said to transmit a further access request for accessing the network node 130. The further access request includes the traffic subscriber identity. Similarly to action A030, the transmission A140 of the further access request may be performed via the wireless device 120 in that the subscriber identity component 110 checks the connection state.

### Action A170

The subscriber identity component 110 may receive, e.g. via the network node 130, the information defining the set of pools from the server node 140. In this manner, the server node 140 may e.g. set the predefined order among the set of pools, add/remove pools from the set of pools, change further criterions like preferred pool etc.

To conclude, the embodiments herein provide a method, performed by the subscriber identity component 110, for assisting the wireless device 120 when seeking connectivity in the network 100, e.g. attempting to access the network node 130. The subscriber identity component 110 is provisioned with information defining a set of pools relating to pool subscriber identities. The subscriber identity component 110 determines a pool subscriber identity based on a pool among the set of pools, e.g. in response to a request for the pool subscriber identity from the wireless device 120. Next, the subscriber identity component 110 may provide, such as store in a memory of the subscriber identity component 110 that is accessible by the wireless device 120, the pool subscriber identity to the wireless device 120.

According to embodiments herein, there is provided a method that ensures that a risk for simultaneous use of two subscriber identities is predictable irrespectively of from which batch the subscriber identity component originates.

With some particular embodiments, global connectivity may be provided thanks to selection of a pool among a plurality of pools.

Furthermore, since the subscriber identity component 110 is only linked to a certain customer, or service provider, via its component identity, the customer may with some embodiments allow the subscriber identity component 110 to be shipped to any location. Then, upon commissioning a traffic subscriber identity—that would be suitable for the location of the first commissioning—may be downloaded according to some of the embodiments herein.

In view of the description above of the combined signaling and flowchart of FIG. 2, it may be noted that the transmission and/or the reception of requests, responses and/or messages may be performed using Short Message Service (SMS) technology, Card Application Toolkit Transport Protocol (CAT-TP) technology, Hypertext Transfer Protocol Secure (HTTPS) technology or the like. In some scenarios, where for example SMS technology is not supported and/or the data load to transfer to the subscriber component is too large for SMS technology, it may be preferred to use HTTPS and/or CAT-TP technology etc.

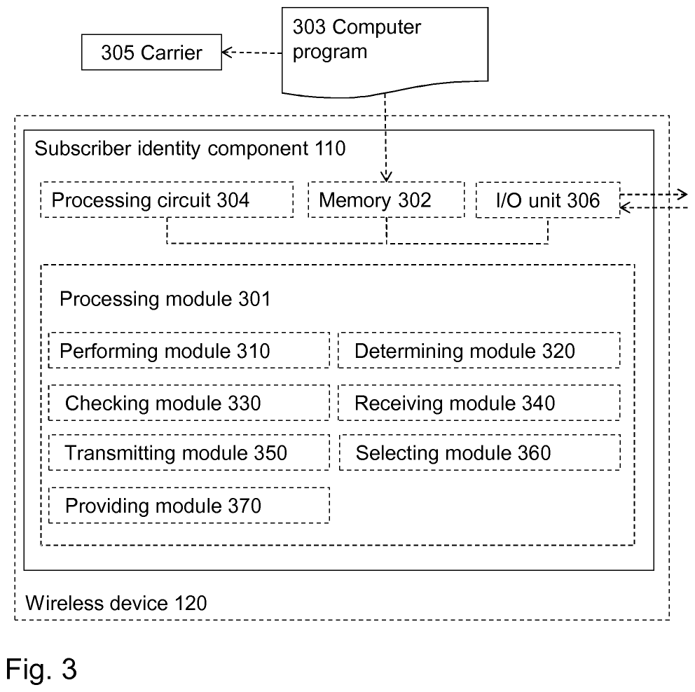

With reference to FIG. 3, a schematic block diagram of embodiments of the subscriber identity component 110 of FIG. 1 is shown.

The subscriber identity component 110 may comprise a processing module 301, such as a means for performing the methods described herein. The means may be embodied in the form of one or more hardware modules and/or one or more software modules

The subscriber identity component 110 may further comprise a memory 302. The memory may comprise, such as contain or store, instructions, e.g. in the form of a computer program 303, which may comprise computer readable code units.

According to some embodiments herein, the subscriber identity component 110 and/or the processing module 301 comprises a processing circuit 304 as an exemplifying hardware module, which may comprise one or more processors. Accordingly, the processing module 301 may be embodied in the form of, or ‘realized by’, the processing circuit 304. The instructions may be executable by the processing circuit 304, whereby the subscriber identity component 110 is operative to perform the methods of FIG. 2. As another example, the instructions, when executed by the subscriber identity component 110 and/or the processing circuit 304, may cause the subscriber identity component 110 to perform the method according to FIG. 2.

In view of the above, in one example, there is provided a subscriber identity component 110 for providing a wireless device 120 with access to a network node 130. As mentioned, the subscriber identity component 110 is provisioned with information defining a set of pools relating to pool subscriber identities. Again, the memory 302 contains the instructions executable by said processing circuit 304 whereby the subscriber identity component 110 is operative for:

determining A020 a pool subscriber identity based on a pool among the set of pools,

checking A030 a connection state relating to whether or not the wireless device 120 is granted access to the network node 130 by use of the pool subscriber identity, and

when the connection state indicates that the wireless device 120 is granted access to the network node 130, providing A045 the wireless device 120 with access to the network node 130 based on the pool subscriber identity.

FIG. 3 further illustrates a carrier 305, or program carrier, which comprises the computer program 303 as described directly above. The carrier 305 may be one of an electronic signal, an optical signal, a radio signal and a computer readable medium.

In some embodiments, the subscriber identity component 110 and/or the processing module 301 may comprise one or more of a performing module 310, a determining module 320, a checking module 330, a receiving module 340, a transmitting module 350, and a selecting module 360 as exemplifying hardware modules. In other examples, one or more of the aforementioned exemplifying hardware modules may be implemented as one or more software modules.

Moreover, the subscriber identity component 110 comprises an Input/Output unit 306, which may be exemplified by the receiving module and/or the transmitting module when applicable.

Accordingly, the subscriber identity component 110 is configured for obtaining a unique subscriber identity for enabling a wireless device 120 to access a network node 130. As mentioned, the subscriber identity component 110 is provisioned with information defining a set of pools relating to pool subscriber identities,

Therefore, according to the various embodiments described above, the subscriber identity component 110 and/or the processing module 301 and/or the determining module 320 is configured for determining a pool subscriber identity based on a pool among the set of pools.

The subscriber identity component 110 and/or the processing module 301 and/or the checking module 330 is configured for checking a connection state relating to whether or not the wireless device 120 is granted access to the network node 130 by use of the pool subscriber identity.

Furthermore, when the connection state indicates that the wireless device 120 is granted access to the network node 130, the subscriber identity component 110 and/or the processing module 301 and/or the providing module 370 is configured for providing the wireless device 120 with access to the network node 130 based on the pool subscriber identity.

In some embodiments, the subscriber identity component 110 and/or the processing module 301 and/or the performing module 310 may be configured for performing a further set of actions, comprising selecting the pool among the set of pools, whereby a respective pool is selected for each time the selection is performed, the determination of the pool subscriber identity, whereby a respective pool subscriber identity is determined for each execution of the determination A020, and the check of the connection state, whereby a respective connection state is checked for each execution of the check A030.

The subscriber identity component 110 and/or the processing module 301 and/or the performing module 310 may be configured for performing the further set of actions while the respective connection state indicates that the wireless device 120 is denied access to the network node 130 and while a number of executions of the selection A010 of the pool is less than or equal to a value representing number of pools in the set of pools.

In some embodiments, the subscriber identity component 110 and/or the processing module 301 and/or the selecting module 360 may be configured for selecting the pool by selecting the pool according to a predefined order for the set of pools, selecting the pool randomly among the set of pools, or selecting the pool based on location of the wireless device 120.

In some embodiments, the subscriber identity component 110 and/or the processing module 301 and/or the transmitting module 350 may be configured for transmitting a first message to a server node 140, wherein the first message comprises a component identity relating to identification of the subscriber identity component 110 comprised in the wireless device 120.

The first message may indicate to the server node 140 that a traffic subscriber identity is requested, and wherein the server node 140 may manage traffic subscriber identities. Then, the subscriber identity component 110 and/or the processing module 301 and/or the receiving module 340 may be configured for receiving at least one second message, comprising the traffic subscriber identity, from the server node 140.

The first message may comprise payload data to be sent to the server node 140, wherein the server node 140 may manage the payload data received from the wireless device 120.

In some embodiment, the subscriber identity component 110 and/or the processing module 301 and/or the receiving module 340 may be configured for receiving, via the network node 130, the information defining the set of pools from the server node 140.

In some embodiments, the subscriber identity component 110 and/or the processing module 301 and/or the receiving module 340 may be configured for receiving a third message from the server node 140. The third message may instruct the subscriber identity component 110 to use the traffic subscriber identity when attaching to the network node 130.

In some embodiments, the subscriber identity component 110 and/or the processing module 301 and/or the transmitting module 350 may be configured for transmitting a further access request for accessing the network node 130, wherein the further access request includes the traffic subscriber identity.

The traffic subscriber identity may be different from the pool subscriber identity determined based on the pool.

The subscriber identity component 110 may have been provisioned with no subscriber identity prior to first start-up.

Said each pool may be associated with a respective region, wherein at least one respective region may be at least partially non-overlapping with at least one further respective region.

Furthermore, FIG. 3 illustrates a wireless device 120 comprising the subscriber identity component 110 according to the embodiments herein.

As used herein, the term “node”, or “network node”, may refer to one or more physical entities, such as devices, apparatuses, computers, servers or the like. This may mean that embodiments herein may be implemented in one physical entity. Alternatively, the embodiments herein may be implemented in a plurality of physical entities, such as an arrangement comprising said one or more physical entities, i.e. the embodiments may be implemented in a distributed manner, such as on cloud system, which may comprise a set of server machines.

As used herein, the term “module” may refer to one or more functional modules, each of which may be implemented as one or more hardware modules and/or one or more software modules and/or a combined software/hardware module in a node. In some examples, the module may represent a functional unit realized as software and/or hardware of the node.

As used herein, the term “computer program carrier”, “program carrier”, or “carrier”, may refer to one of an electronic signal, an optical signal, a radio signal, and a computer readable medium. In some examples, the computer program carrier may exclude transitory, propagating signals, such as the electronic, optical and/or radio signal. Thus, in these examples, the computer program carrier may be a non-transitory carrier, such as a non-transitory computer readable medium.

As used herein, the term “processing module” may include one or more hardware modules, one or more software modules or a combination thereof. Any such module, be it a hardware, software or a combined hardware-software module, may be a determining means, estimating means, capturing means, associating means, comparing means, identification means, selecting means, receiving means, sending means or the like as disclosed herein. As an example, the expression “means” may be a module corresponding to the modules listed above in conjunction with the Figures.

As used herein, the term “software module” may refer to a software application, a Dynamic Link Library (DLL), a software component, a software object, an object according to Component Object Model (COM), a software component, a software function, a software engine, an executable binary software file or the like.

The terms “processing module” or “processing circuit” may herein encompass a processing unit, comprising e.g. one or more processors, an Application Specific integrated Circuit (ASIC), a Field-Programmable Gate Array (FPGA) or the like. The processing circuit or the like may comprise one or more processor kernels.

As used herein, the expression “configured to/for” may mean that a processing circuit is configured to, such as adapted to or operative to, by means of software configuration and/or hardware configuration, perform one or more of the actions described herein.

As used herein, the term “action” may refer to an action, a step, an operation, a response, a reaction, an activity or the like. It shall be noted that an action herein may be split into two or more sub-actions as applicable. Moreover, also as applicable, it shall be noted that two or more of the actions described herein may be merged into a single action.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), Secure Digital (SD) card, etc. One or more of the aforementioned examples of computer readable medium may be provided as one or more computer program products.

As used herein, the term “computer readable code units” may be text of a computer program, parts of or an entire binary file representing a computer program in a compiled format or anything there between.

As used herein, the expression “transmit” and “send” are considered to be interchangeable. These expressions include transmission by broadcasting, uni-casting, group-casting and the like. In this context, a transmission by broadcasting may be received and decoded by any authorized device within range. In case of uni-casting, one specifically addressed device may receive and decode the transmission. In case of group-casting, a group of specifically addressed devices may receive and decode the transmission.

As used herein, the terms “number” and/or “value” may be any kind of digit, such as binary, real, imaginary or rational number or the like. Moreover, “number” and/or “value” may be one or more characters, such as a letter or a string of letters. “Number” and/or “value” may also be represented by a string of bits, i.e. zeros and/or ones.

As used herein, the terms “first”, “second”, “third” etc. may have been used merely to distinguish features, apparatuses, elements, units, or the like from one another unless otherwise evident from the context.

As used herein, the term “set of” may refer to one or more of something. E.g. a set of devices may refer to one or more devices, a set of parameters may refer to one or more parameters or the like according to the embodiments herein.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1. A method, performed by a subscriber identity component, for providing a wireless device with access to a network node, the subscriber identity component being provisioned with information defining a set of pools relating to pool subscriber identities, the method comprising:
determining a pool subscriber identity based on a pool among the set of pools;
checking a connection state relating to whether or not the wireless device is granted access to the network node by use of the pool subscriber identity; and
when the connection state indicates that the wireless device is granted access to the network node, providing the wireless device with access to the network node based on the pool subscriber identity.

2. The method according to claim 1, wherein the method comprises:
performing a further set of actions, comprising:
selecting the pool among the set of pools, whereby a respective pool is selected for each time the selection is performed;
the determination of the pool subscriber identity, whereby a respective pool subscriber identity is determined for each execution of the determination; and
the check of the connection state, whereby a respective connection state is checked for each execution of the check,
wherein the further set of actions is performed while the respective connection state indicates that the wireless device is denied access to the network node and while a number of executions of the selection of the pool is less than or equal to a value representing number of pools in the set of pools.

3. The method according to claim 2, wherein the selecting of the pool comprises one of:
selecting the pool according to a predefined order for the set of pools;
selecting the pool randomly among the set of pools; and
selecting the pool based on location of the wireless device.

4. The method according to claim 1, further comprising:
transmitting a first message to a server node, wherein the first message comprises a component identity relating to identification of the subscriber identity component comprised in the wireless device.

5. The method according to claim 4, wherein the first message indicates to the server node that a traffic subscriber identity is requested, and wherein the server node manages traffic subscriber identities, wherein the method further comprises:
receiving at least one second message, comprising the traffic subscriber identity, from the server node.

6. The method according to claim 4, wherein the first message comprises payload data to be sent to the server node, wherein the server node manages the payload data received from the wireless device.

7. The method according to claim 1, further comprising:
receiving, via the network node, the information defining the set of pools from the server node.

8. The method according to claim 1, further comprising:
receiving a third message from the server node, wherein the third message instructs the subscriber identity component to use the traffic subscriber identity when attaching to the network node.

9. The method according to claim 1, further comprising:
transmitting a further access request for accessing the network node, wherein the further access request includes the traffic subscriber identity.

10. The method according to claim 1, wherein the traffic subscriber identity is different from the pool subscriber identity determined based on the pool.

11. The method according to claim 1, wherein the subscriber identity component has been provisioned with no subscriber identity prior to first start-up.

12. The method according to claim 1, wherein each pool is associated with a respective region, wherein at least one respective region is at least partially non-overlapping with at least one further respective region.

13. (canceled)

14. A wireless device comprising a subscriber identity component, according to the preceding claim, the subscriber identity component providing a wireless device with access to a network node, the subscriber identity component being provisioned with information defining a set of pools relating to pool subscriber identities, the subscriber identity component being configured to:
determine a pool subscriber identity based on a pool among the set of pools;
check a connection state relating to whether or not the wireless device is granted access to the network node by use of the pool subscriber identity; and
when the connection state indicates that the wireless device is granted access to the network node, providing the wireless device with access to the network node based on the pool subscriber identity.

15. A computer storage medium storing an executable computer program, the computer program comprising computer readable code units which when executed on a subscriber identity component causes the subscriber identity component to perform a method for providing a wireless device with access to a network node, the subscriber identity component being provisioned with information defining a set of pools relating to pool subscriber identities, the method comprising:
determining a pool subscriber identity based on a pool among the set of pools;
checking a connection state relating to whether or not the wireless device is granted access to the network node by use of the pool subscriber identity; and
when the connection state indicates that the wireless device is granted access to the network node, providing the wireless device with access to the network node based on the pool subscriber identity.

16. (canceled)

17. The method according to claim 2, further comprising:
transmitting a first message to a server node, wherein the first message comprises a component identity relating to identification of the subscriber identity component comprised in the wireless device.

18. The method according to claim 17, wherein the first message indicates to the server node that a traffic subscriber identity is requested, and wherein the server node manages traffic subscriber identities, wherein the method further comprises:
receiving at least one second message, comprising the traffic subscriber identity, from the server node.

19. The method according to claim 17, wherein the first message comprises payload data to be sent to the server node, wherein the server node manages the payload data received from the wireless device.

20. The method according to claim 2, further comprising:
receiving, via the network node, the information defining the set of pools from the server node.

21. The method according to claim 2, further comprising:
receiving a third message from the server node, wherein the third message instructs the subscriber identity component to use the traffic subscriber identity when attaching to the network node.

22. The method according to claim 2, further comprising:
transmitting a further access request for accessing the network node, wherein the further access request includes the traffic subscriber identity.
